(19) United States
(12) Patent Application Publication
(10) Pub. No.: US 2014/0089772 A1
(43) Pub. Date: Mar. 27, 2014

(54) Automatically Creating Tables of Content for Web Pages

(71) Applicants: Gururaj B. Shetty, Bangalore (IN); Saravanan Dharmaraj, Bangalore (IN); Michael G. Danies, Beaverton, OR (US)

(72) Inventors: Gururaj B. Shetty, Bangalore (IN); Saravanan Dharmaraj, Bangalore (IN); Michael G. Danies, Beaverton, OR (US)

(21) Appl. No.: 13/628,354

(22) Filed: Sep. 27, 2012

(51) Int. Cl. G06F 17/00

(52) U.S. Cl. 715/206

(57) ABSTRACT

A table of contents may be automatically created for a web page. This table of contents may then be used by the visually impaired to navigate the web page via the table of contents. A user may selectively navigate the web page or the table of contents. The user can access items on the web page by selecting an item in the table of contents. Thus in some embodiments, instead of selectively opening portions of the web page and incurring the time penalty associated therewith, the user can simply move through entries in the table of contents until the user finds the information that is actually desired.

### BACKGROUND

This relates generally to computer tools for the visually impaired.

Visually impaired persons generally navigate web pages using assistive technologies involving text-to-speech tools. These tools have many deficiencies. Navigating a website with a table structure becomes difficult and confusing because the areas or cells within the web page are undefined. Assistive technology reads out nothing informative but the highlighted text. To navigate through the various sections or parts of such a web page, the visually impaired user must make multiple tab hits before reaching the information that visually unimpaired users can quickly see and click on.

Many web publishers insert a link at the top of the web page for the visually impaired. When this link is clicked on, it sets the user's cursor focus to one of the main parts of the web page. Then assistive technologies read the entire document object model (DOM) tree of the web page. This allows the user to navigate using the tab key strokes to each and every section of the web page.

Document object model (DOM) is an application program interface for valid Hypertext Markup Language (HTML) and Extensible Markup Language (XML) documents. It defines the logical structure for documents and specifies the way that documents are accessed and manipulated. With the document object model, programmers can build documents, navigate document structure, and add, modify and delete elements and content. Anything found in an HTML or XML document can be modified using the document object model. The object structure closely resembles the structure of the modeled documents.

A graphical representation of the document object model is called a tree and shows the connections between the various objects. Documents have a logical structure like a tree. Each document contains zero to one doc type node, one root element node and zero or more comments or processing instructions. The root element serves as the root of the element tree for the document.

### BRIEF DESCRIPTION OF THE DRAWINGS

Some embodiments are described with respect to the following figures:

FIG. 1 is a depiction of a graphical user interface in accordance with one embodiment;

FIG. 2 is a graphical user interface in accordance with one embodiment;

FIG. 3 is a graphical user interface in accordance with one embodiment showing the techniques for building a table of contents using the document object model tree builder;

FIG. 4 is a depiction of a portion of a graphical user interface in accordance with one embodiment;

FIG. 5 is a depiction of a graphical user interface in accordance with one embodiment;

FIG. 6 is a flow chart for one embodiment; and

FIG. 7 is a system depiction for one embodiment.

### DETAILED DESCRIPTION

In accordance with some embodiments as described herein, a table of contents may be automatically created for a web page. This table of contents may then be used, more effectively in some embodiments, by the visually impaired to navigate the web page via the table of contents. A user may selectively navigate the web page or the table of contents. The users are enabled to access items on the web page by selecting an item in the table of contents. Thus in some embodiments, instead of selectively opening portions of the web page and incurring the time penalty associated therewith, the user can simply move through entries in the table of contents until the user finds the information that is actually desired.

In some embodiments, the amount of time that is needed and the ability to move forwards and backwards through the table of contents may facilitate location of information into more expeditious fashion.

A simple framework may be used to enable the automatic creation of the table of contents. For example, JavaScript may be used or an addendum to the HTML specification could be proposed so that browsers may include it as a feature. In one embodiment, the table of contents may be implemented as a drop down box but other graphical user interfaces may also be used. In an embodiment where a drop down box is used, a short cut key like Alt+1 may be used to access the drop down box. Again, other short cut keys or techniques may also be used.

The values in the drop down box may be populated based on attributes defined by the authors of the section or portlet. A portlet is pluggable user interface software managed and displayed in a web portal. In addition, when focus hits the drop down menu, the system may describe what the page is all about, and how the contents are laid out, such as by tabs, columns, sections, etc. This may all be provided in a way so that assistive technology tools can convert this information to speech. Also authors can define this information using a tag specifically designed for Americans with Disabilities Act (ADA) compliance like <ada_page_info>.

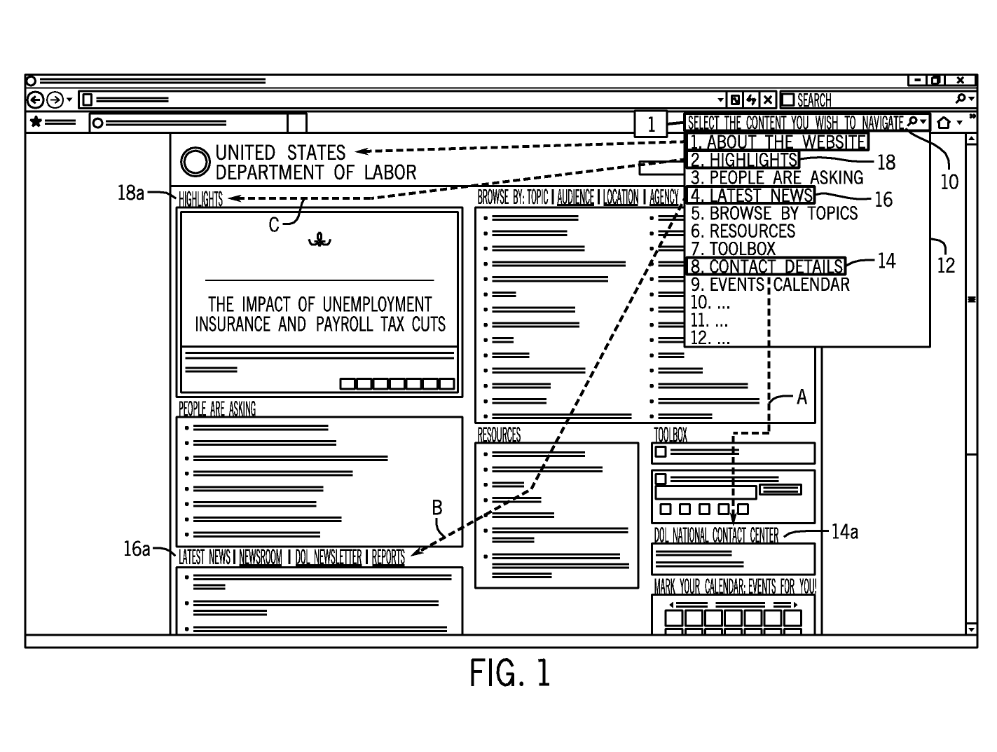

Thus referring to FIG. 1, an example of a website implemented in accordance with some embodiments of the present invention is depicted. In the upper right hand corner may be a hot spot that can be utilized to select content. In some cases, this hot spot is provided in the same location within all web pages so that the visually impaired can readily find it.

Upon selection of the hot spot 10, a table of contents 12 may be automatically generated. The table may provide a number of entries corresponding to topics or headings within the web page. Thus for example the first entry 18 may always provide an overview layout in some embodiments. This layout may be programmed by the author in order to provide the visually impaired with an overall introduction to the way information is provided on the web page. The next entry may be highlights 18 that may give some of the more important topics that are contained at 18a within the webpage (as indicated via arrow C) in some embodiments. The next entry may describe what people are asking (i.e. frequently asked questions) in some embodiments. Then, the next entry 16 may be the latest news that corresponds to the website heading latest news at 16a (as indicated via arrow B). Item number 5 allows the user to browse by topics, item 6 gives resources, item 7 gives a tool box, contact details are given at 14, which links as indicated via the arrow A to the website area 14a, which gives conventional content information. Other entries may include an events calendar. In many embodiments, the table of contents includes standard fields as well as fields automatically generated from the content of the web page and fields populated as programmed by the website author.

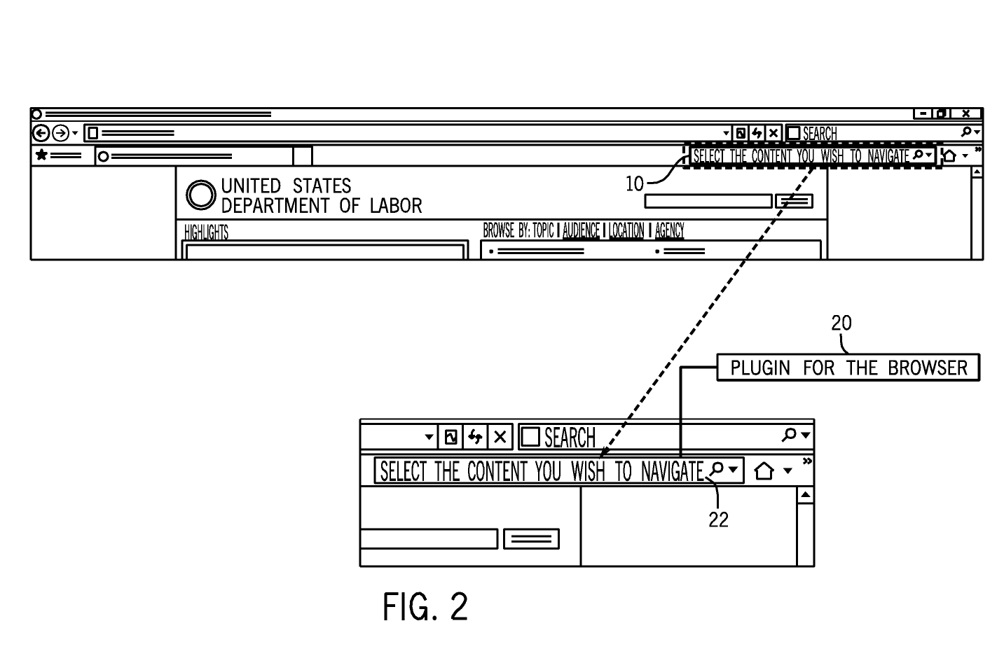

Turning next to FIG. 2, a plug-in or add-on 20 may be added to the web browser to automatically create, in one embodiment the drop down menu box 12 in FIG. 1. Then, when the user clicks on the hot spot 10, as shown in an enlarged region 22, the plug-in for the browser is activated at 20.

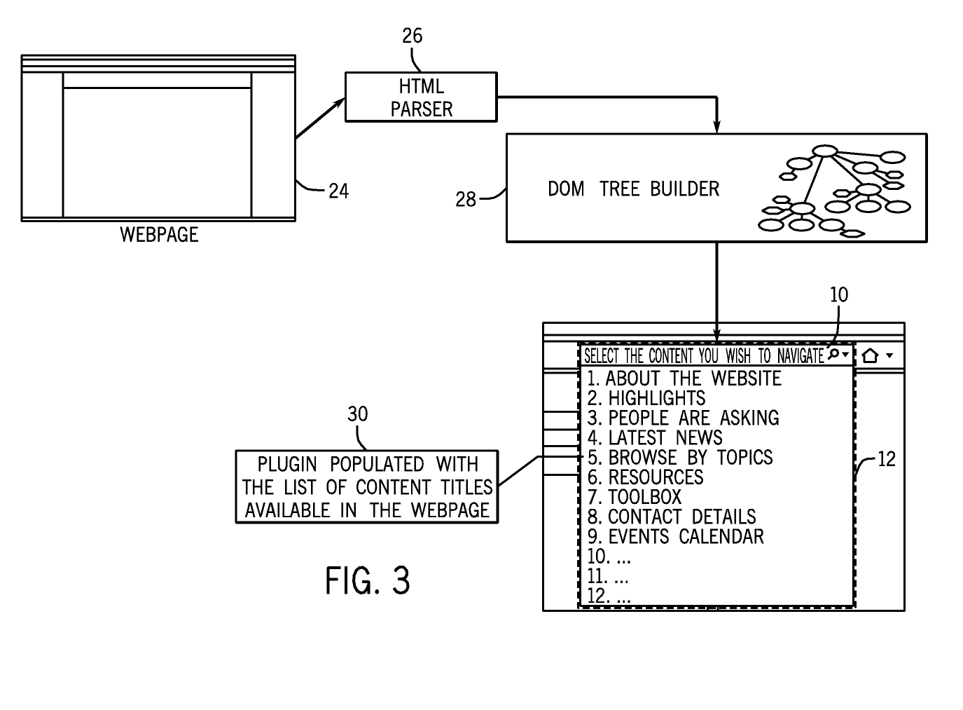

Referring to FIG. 3, the plug-in or add-on uses a document object model (DOM) tree builder structure 28 to identify the titles or sections with ADA tags on the web page and populates the drop down menu with a table of contents. Thus, the web page 24 is analyzed by an HTML parser 26 to create the document object model tree builder structure 28. The structure 28 is then used to populate the drop down menu implemented table of contents 12 when the user selects the select content you wish to navigate hot spot 10. The plug-in is populated with a list of content titles available on the page as indicated 30.

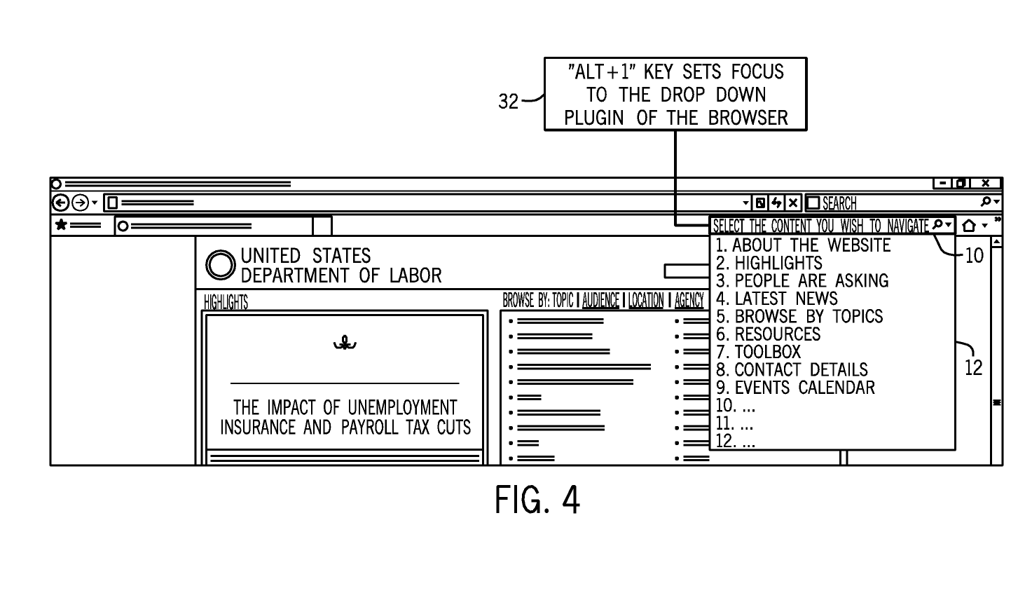

Moving on to FIG. 4, the user uses an assigned keystroke such as Alt+1 to access the drop down menu as indicated at 32. For example, the user can hit Alt+1 keys and set the focus on the drop down menu 12. As indicated at 32, in one embodiment, the Alt+1 key sets focus to the drop down menu plug-in of the browser activating the hot spot 10 that is selectable to build the drop down box implemented table of contents 12. Other keystrokes or even voice or gesture commands may be used.

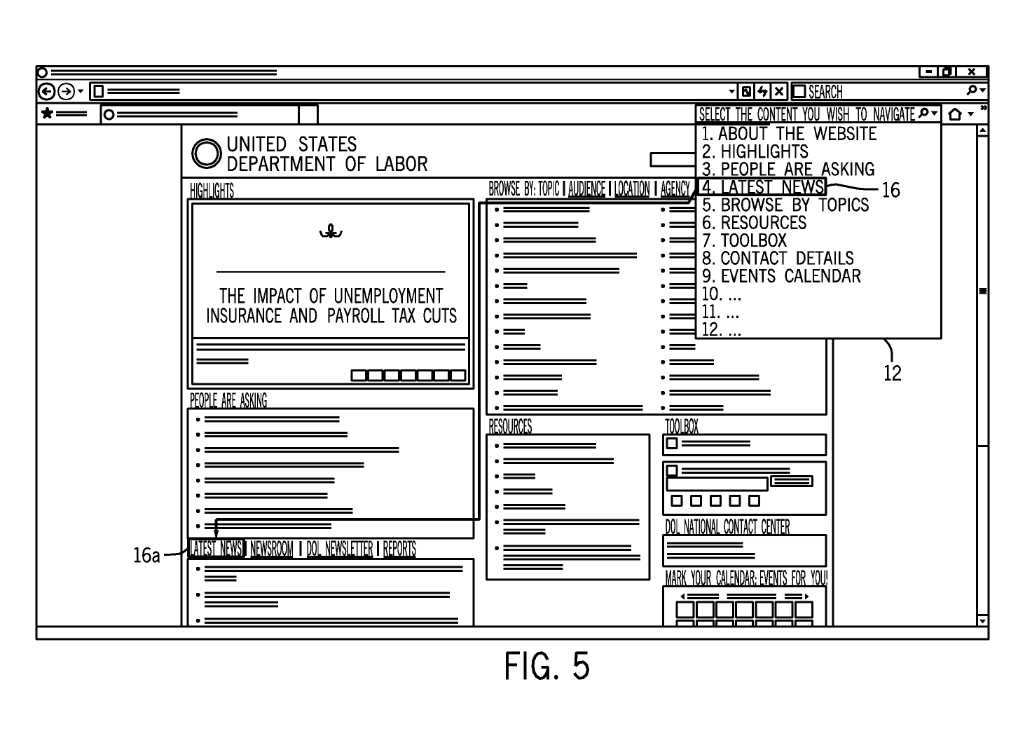

Moving on to FIG. 5, using keyboard or touch screen arrow keys in one embodiment, the user can navigate through the drop down list and select one of the listed items by hitting ENTER or RETURN on a keyboard or touch screen to navigate to the content title. Pushing an ENTER or RETURN key sets the cursor focus on the content title. Then in one embodiment, using the tab key or some other key, the user can navigate through the content section. If the user selects latest news 16 in the drop down menu, the user automatically gets the content associated with the heading “latest news” 16a in the web page. Voice or gestural commands may also be used.

Thus, the basic mode of operation in some embodiments may be, when the user loads the web page and hits the tab key to start navigating through the web page, the focus is first set to skip to the page content link that is mostly available at the top of the web page. The assistive technology application reads this text to the user. On clicking ENTER on this link, the focus is set to the main content area of the web page, skipping all the way through intermediate links. In the example above, focus is set to highlights and the links A to Z, Site Map, FAQs, Forms, etc. are skipped.

From here the user has to keep hitting the tab key to navigate through the web page. In order to navigate back up to a particular part of the web page, the user merely can hit an assigned key, like SHIFT+tab, and go through each and every element until the user reaches the desired content. Finally, the tab keystroke may set focus to the very next HTML element, which can be an image, table, column, a horizontal line page break, etc. Voice or gestural commands may also be used.

In some embodiments this technology may be used in web browsers and may be applied by web browser developer and content authors and may be used by web page developers. It may be used as a Word document reader, a portable document format (PDF) technology reader and mobile browser or as an e-book reader, to give some more examples.

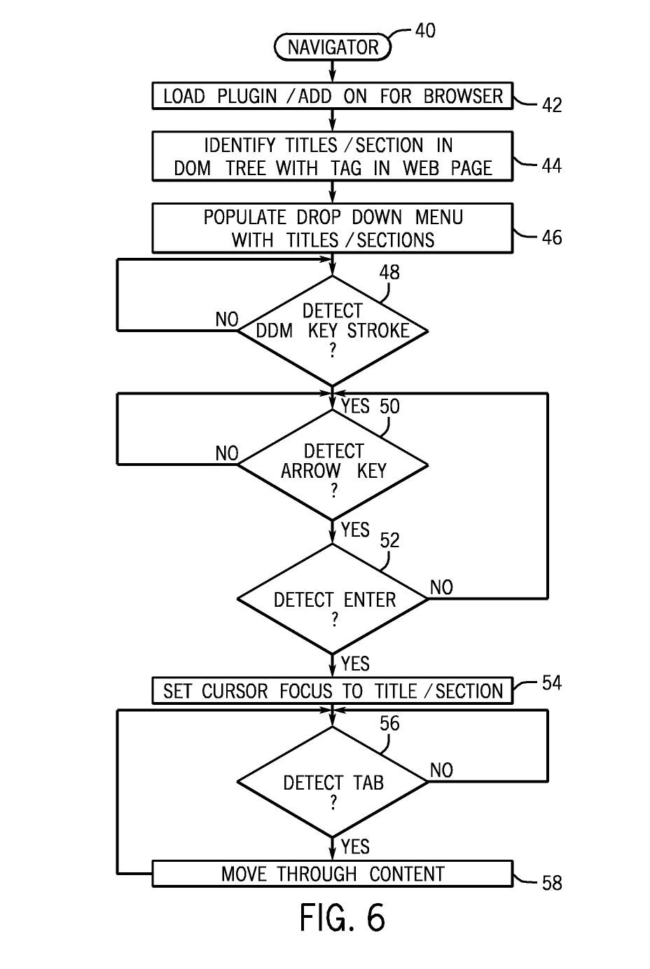

The navigator sequence 40 shown in FIG. 6 may be implemented in software, firmware and/or hardware. In software and firmware embodiments it may be implemented by computer executed instructions stored in one or more non-transitory computer readable media such as magnetic, optical or semiconductor storages.

The sequence 40 may begin by loading the plug-in or add-on for the browser as indicated at block 42. Then the titles and sections in the document object model tree may be identified automatically with tags in the web page as indicated in block 44. The drop down menu may be populated with the titles and sections as indicated in block 46.

A check at diamond 48 determines whether there is detection of a drop down menu (DDM) keystroke 48. If so, a check at diamond 50 determines whether an arrow key has been operated. Finally a check at diamond 52 detects when an ENTER or RETURN key is entered. When an ENTER or RETURN key is detected, the cursor focus is set to the selected title or section as indicated in block 54. When the tab key is detected at diamond 56, the assistive technology reads through the content as indicated in block 58. Voice or gestural commands may also be used.

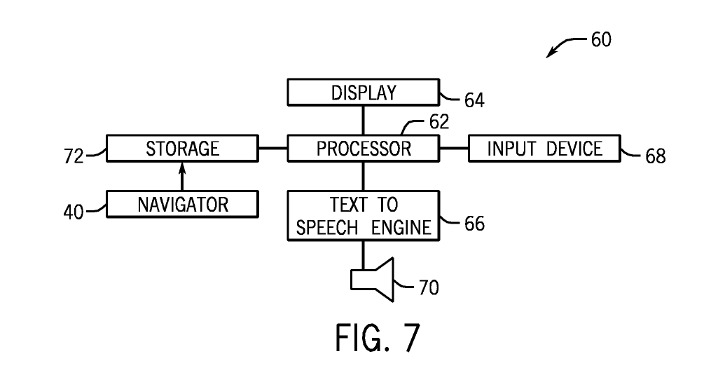

Referring to FIG. 7, any processor based system may implement embodiments, as described herein, including desktop, laptop computers, tablets, mobile Internet devices, cellular telephones, kiosks, or any other processor based device.

### Additional Notes and Examples

One example embodiment may be an apparatus comprising a module to build a table of contents for a web page, an input device to enable a user to selectively navigate the web page or the table of contents, and to enable the user to access items on the web page by selecting an entry in said table of contents, a parser coupled to said module; and a text to speech engine coupled to said module. The apparatus may include said processor to create the table of contents by locating markers in the web page. The apparatus may include said processor to use a document model tree to build said table of contents. The apparatus may include a parser to locate tags in said web page to create said table of contents.

Another example embodiment may be a computer implemented method comprising automatically creating a table of contents for a web page, enabling a user to selectively navigate the web page or the table of contents; and enabling the user to access items on the web page by selecting an entry in said table of contents. The method may include locating markers in the web page identifying topics for the visually impaired. The method may include creating the table of contents using a document object model tree. The method may include providing an item in said table of contents that may be selected to describe the structure of the web site. The method may include presenting said table of contents as a drop down menu. The method may include providing a plug-in or add-on to a browser to create said table of contents. The method may include using a parser to locate tags in the web page to populate said table of contents. The method may include enabling the user to move through multiple entries in said table of contents without necessarily viewing the corresponding topic on the web page. The method may perform by one of control key sequence or voice selection.

Another example embodiment may be one or more computer readable storage media storing instructions to enable a computer to perform a sequence comprising creating a table of contents for a web page, receiving a selection to directly navigate the web page or the table of contents; and accessing an item on the web page when an entry in said table of contents is selected. The media may further store instructions to perform a sequence including locating markers in the web page identifying topics for the visually impaired. The media may further store instructions to perform a sequence including creating a table of contents using a document object model tree. The media may further store instructions to perform a sequence including providing an item in said table of contents that may be selected to describe the structure of the web site. The media may further store instructions to perform a sequence including presenting said table of contents as a drop down menu. The media may further store instructions to perform a sequence including providing a plug-in or add-on to a browser to create said table of contents. The media may further store instructions to perform a sequence including using a parser to locate tags in the web page to populate said table of contents. The media may further store instructions to perform a sequence including enabling the user to move through multiple entries in said table of contents without necessarily viewing the corresponding topic on the web page. The media may further store instructions to perform a sequence in response to a control key sequence or voice selection.

One embodiment, shown in FIG. 7 includes a processor 62 coupled to a display 64. An input device 68, such as a keyboard or mouse, or voice recognition unit an microphone (not shown), may be connected to the processor 62. A text-to-speech engine 66 may be coupled to the processor 62 and a speaker 60. A storage 72, coupled to the processor 62, may for example, store the navigator software 40 in one embodiment. Thus, a system 60 may be any conventional processor based device.

References throughout this specification to “one embodiment” or “an embodiment” mean that a particular feature, structure, or characteristic described in connection with the embodiment is included in at least one implementation encompassed within the present invention. Thus. appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a module to build a table of contents for a web page;
an input device to enable a user to selectively navigate the web page or the table of contents, and to enable the user to access items on the web page by selecting an entry in said table of contents;
a parser coupled to said module; and
a text to speech engine coupled to said module.

2. The apparatus of claim 1 said processor to create the table of contents by locating markers in the web page.

3. The apparatus of claim 1 said processor to use a document model tree to build said table of contents.

4. The apparatus of claim 1 including a parser to locate tags in said web page to create said table of contents.

5. A computer implemented method comprising:
automatically creating a table of contents for a web page;
enabling a user to selectively navigate the web page or the table of contents; and
enabling the user to access items on the web page by selecting an entry in said table of contents.

6. The method of claim 5 including locating markers in the web page identifying topics for the visually impaired.

7. The method of claim 6 including creating the table of contents using a document object model tree.

8. The method of claim 5 including providing an item in said table of contents that may be selected to describe the structure of the web site.

9. The method of claim 5 including presenting said table of contents as a drop down menu.

10. The method of claim 5 including providing a plug-in or add-on to a browser to create said table of contents.

11. The method of claim 5 including using a parser to locate tags in the web page to populate said table of contents.

12. The method of claim 5 including enabling the user to move through multiple entries in said table of contents without necessarily viewing the corresponding topic on the web page.

13. The method of claim 5 performed by one of control key sequence or voice selection.

14. One or more computer readable storage media storing instructions to enable a computer to perform a sequence comprising:
creating a table of contents for a web page;
receiving a selection to directly navigate the web page or the table of contents; and
accessing an item on the web page when an entry in said table of contents is selected.

15. The media of claim 14 further storing instructions to perform a sequence including locating markers in the web page identifying topics for the visually impaired.

16. The media of claim 14 further storing instructions to perform a sequence including creating a table of contents using a document object model tree.

17. The media of claim 14 further storing instructions to perform a sequence including providing an item in said table of contents that may be selected to describe the structure of the web site.

18. The media of claim 14 further storing instructions to perform a sequence including presenting said table of contents as a drop down menu.

19. The media of claim 14 further storing instructions to perform a sequence including providing a plug-in or add-on to a browser to create said table of contents.

20. The media of claim 14 further storing instructions to perform a sequence including using a parser to locate tags in the web page to populate said table of contents.

21. The media of claim 14 further storing instructions to perform a sequence including enabling the user to move through multiple entries in said table of contents without necessarily viewing the corresponding topic on the web page.

22. The media of claim 14 further storing instructions to perform a sequence in response to a control key sequence or voice selection.
